(19) United States
(12) Patent Application Publication
(10) Pub. No.: US 2017/0082364 A1
(43) Pub. Date: Mar. 23, 2017

(54) INDUSTRIAL FURNACE FOR HEATING PRODUCTS SUCH AS STEEL PRODUCTS

(71) Applicant: Cockerill Maintenance & Ingenierie S.A., Seraing (BE)

(72) Inventors: Ludovic Ferrand, Saint-Germain-En-Laye (FR); Patrick Dubois, Andrezel (FR); Eduardo Pinto de Sousa, Paris (FR)

(21) Appl. No.: 15/122,931

(22) PCT Filed: Feb. 20, 2015
(86) PCT No.: PCT/EP2015/053581

§ 371 Date: Sep. 1, 2016

(30) Foreign Application Priority Data
Mar. 4, 2014 (FR) 1451767

(51) Int. Cl. F27B 9/30; F27D 17/00; F27B 9/36; F27B 9/20

(52) U.S. Cl. CPC F27B 9/3044; F27B 9/20; F27D 17/004; F27D 17/008; F27B 9/36; F27D 2017/007

(57) ABSTRACT

An industrial furnace for heating products such as steel products includes a thermally insulated enclosure, a plurality of burners arranged in the enclosure for heating products passing from one end of the enclosure to the other, the burners being distributed over a plurality of temperature-regulated heating areas, and a recovery system designed for recovering heat energy from recovery fumes, The recovery system includes a rotary regenerator associated with each heating area, each of the rotary regenerators being configured to receive a predetermined flow rate of recovery fumes via a first duct, receive a predetermined flow rate of supply air via a second duct, preheat the supply air in order to supply the burners of the associated heating area with a predetermined flow rate of preheated combustion air via a third duct, and discharge exhaust fumes via a fourth duct.

### CROSS REFERENCE TO RELATED APPLICATIONS

This application is a U.S. National Stage Application under 35 U.S.C. §371 of International Application No. PCT/EP2015/053581 filed on Feb. 20, 2015, and claims benefit to French Patent Application No. 1451767 filed on Mar. 4, 2014. The International Application was published in French on Sep. 11, 2015 as WO 2015/132082 A1 under PCT Article 21(2).

### FIELD

The invention relates to an industrial furnace for heating products, e.g. steel products.

### BACKGROUND

Numerous industrial furnaces for heating steel products, such as for example preheating furnaces for processing steel coils, comprise a thermally-insulated enclosure and a plurality of burners arranged in the enclosure for heating steel products passing through the enclosure.

The burners, conventionally distributed over several temperature-regulated heating areas, are fed with combustion air and with fuel of the natural gas type, producing, by way of first combustion, flames that heat the steel products and generate fumes flowing in the opposite direction to said steel products. Those fumes are themselves generally processed by a second combustion referred to as “post-combustion”, for the purpose of ensuring complete combustion that makes it possible to remove at least some polluting gas such as carbon monoxide from the fumes. The resulting and less polluted fumes are then discharged from the furnace and released into the atmosphere via a chimney.

The energy consumption of preheating furnaces for processing steel coils is particularly high, of the order of 220 kilowatt-hours (kWh) of natural gas per (metric) tonne of heated steel. It is therefore particularly important, both from an environmental point of view and from an economical point of view, to try to improve the energy efficiency of such furnaces.

To do this, a first method that is conventionally used consists in fitting the furnaces with energy recovery means for recovering heat that is lost in the fumes. Those recovery means are typically constituted by a shell-and-tube heat exchanger having metal tubes conveying the flow of combustion air used by the burners. By flowing around the tubes, the fumes preheat the combustion air, and that improves the efficiency of the above-mentioned first combustion. However, such heat recovery is limited by the maximum acceptable temperature that the tubes can withstand, which makes it necessary to dilute the fumes with cold air.

A second method, which has now largely overtaken the first method, consists in using regenerative burners. However, that solution presents a certain number of drawbacks. Firstly, the regenerative burners are not adapted to sucking fumes that are loaded with unburned residues into the burner, since it then becomes impossible to perform post-combustion. In addition, that solution is difficult to apply to furnaces that are compact, firstly due to the bulkiness of the regenerative vessels with which the burners are fitted, and secondly due to the need for installing twice as many regenerative burners compared to the number of burners for a standard solution. Regenerative burners operate in pairs, and their operation is cyclical: half of the time the burners are in a combustion mode and the other half of the time they are in a heat-accumulation mode.

### SUMMARY

In an embodiment, the present invention provides an industrial furnace for heating products such as steel products, the furnace including a thermally-insulated enclosure; a plurality of burners arranged in the enclosure for heating products passing from one end of the enclosure to the other, the burners being distributed over a plurality of temperature-regulated heating areas; and a recovery system for recovering heat energy from recovery fumes by a first combustion performed by the burners in such a manner as to improve energy efficiency of the furnace. The recovery system includes a rotary regenerator associated with each heating area, each of the rotary regenerators being configured to receive a predetermined flow rate of recovery fumes via a first duct, receive a predetermined flow rate of supply air via a second duct, preheat the supply air in order to supply the burners of the associated heating area with a predetermined flow rate of preheated combustion air via a third duct, and discharge exhaust fumes via a fourth duct.

### BRIEF DESCRIPTION OF THE DRAWING

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 depicts diagrammatically an industrial furnace according to an embodiment of the invention.

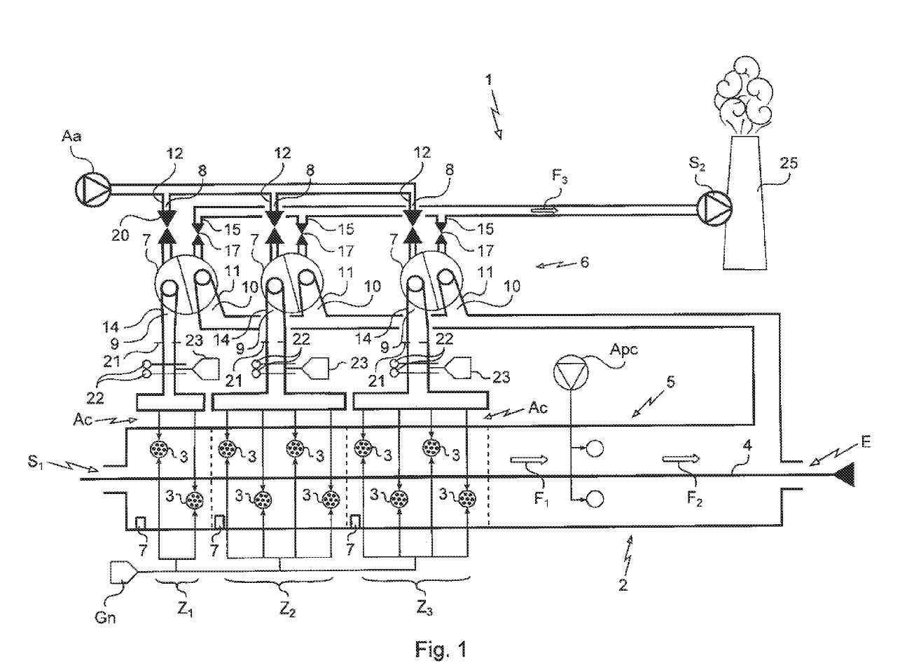

### DETAILED DESCRIPTION

According to an embodiment, the invention provides an industrial furnace having increased energy efficiency while also being of acceptable size. The invention provides an industrial furnace for heating products such as steel products, the furnace comprising a thermally-insulated enclosure and a plurality of burners arranged in the enclosure for heating the products passing from one end of the enclosure to the other, the burners being distributed over a plurality of temperature-regulated heating areas. The furnace further comprises recovery systems designed for recovering heat energy from recovery fumes by way of a first combustion performed by the burners in such a manner as to improve energy efficiency of the furnace. According to an embodiment of the invention, the recovery systems comprise a rotary regenerator associated with each heating area, each of the rotary regenerators being suitable for receiving a predetermined flow rate of recovery fumes via a first duct, for receiving a predetermined flow rate of supply air via a second duct, for preheating said supply air in order to supply the burners of the associated heating area with a predetermined flow rate of preheated combustion air via a third duct, and for discharging exhaust fumes via a fourth duct.

Thus, the energy efficiency of the furnace is improved by heat energy recovery performed by rotary regenerators that are of a size that is acceptable for most industrial furnaces.

An embodiment of the invention relates to an industrial furnace for heating products such as steel products, and is in this example, is put into application in a furnace for non-oxidizing preheating of strips of steel for lines that process steel coil continuously.

The furnace 1 comprises a thermally-insulated enclosure 2, a plurality of burners 3 arranged in the enclosure 2 in order to perform first combustion and to heat a steel strip 4 passing from one end of the enclosure to the other 2, a system referred to as “post-combustion” system 5 suitable for performing second combustion, and recovery system 6.

The plurality of burners 3 is in this example constituted of ten burners 3 distributed over a plurality of temperature-regulated heating areas, specifically over three heating areas Z1, Z2, Z3. This distribution makes it possible to regulate the temperature of the furnace 1 by way of only three thermocouples 7 positioned in the heating areas Z1, Z2, Z3, so as to make the temperature of the furnace match predetermined heat curves that depend in particular on a preferred strip temperature at a strip outlet Si of the furnace 1. The heating areas Z1, Z2, Z3 are thus regulated to comply with temperature setpoints typically lying in the range 1200 to 1350 degrees Celsius for a preferred strip temperature at the strip outlet S1 of the furnace 1 lying in the range 550 to 750 degrees Celsius.

The first combustion performed by the burners 3 requires a fuel, in this example natural gas, and an oxidizer, in this example combustion air Ac.

In this example, the burners 3 operate in “sub-stoechiometric” operating conditions, also known as low-air combustion or gas-rich combustion. Under sub-stoechiometric operating conditions, the flow of combustion air is always less than the flow of air necessary for completely burning the flow of natural gas Gn that is introduced into a single burner. First combustion fumes F1 are thus generated by the burners 3, said first combustion fumes F1 having been subjected to combustion that is said to be “incomplete”, having an oxygen content that is almost zero, the oxygen in the combustion air being entirely (or almost entirely) combined with the natural gas. Sub-stoechiometric operating conditions are particularly advantageous since they enable first combustion fumes F1 to be provided that have a reducing effect on the strip of steel 4, which makes it possible to avoid oxide formation on the steel strip, e.g. oxides of the iron oxide type, and which even makes it possible to reduce certain oxides that might be present on the steel strip before said first combustion. Thus, the quality of the steel strip preheated by the furnace of an embodiment of the invention is improved.

After the first combustion, the fumes F1 are loaded with intermediate compounds, e.g. with dihydrogen or with carbon monoxide. The carbon monoxide must not be released into the atmosphere because it is a pollutant which emissions are regulated.

Post-combustion system 5 is therefore used in order to perform the second combustion, which consists in injecting air referred to as “post-combustion air” Apc, which air is to finish off the first combustion, as performed by the burners 3, in such a manner as to remove the intermediate compounds from the first combustion fumes F1. Since the first combustion fumes F1 generally flow in the opposite direction to the steel strip 4, the post-combustion system 5 is situated in the furnace 1 upstream from the burners 3, i.e. they are situated between an inlet E of the furnace and the burners 3. The post-combustion air Apc is injected by the post-combustion system 5 at a flow rate of post-combustion air Apc that is measured in order to ensure that combustion is complete but without adding unnecessary air. Advantageously, the post-combustion air Apc is injected into an area of the enclosure in which the steel strip has a temperature that is too low for suffering the effects of oxidization caused by excess oxygen in the post-combustion air Apc. Alternatively, the post-combustion air Apc may be injected from fume evacuation flues.

The second combustion generates recovery fumes F2 that are depolluted at least in part.

The recovery system 6 is designed to recover heat energy from the recovery fumes F2, which fumes thus result both from the first combustion and from the second combustion. The energy efficiency of the furnace 1 is thus improved.

The recovery system 6 comprises a rotary regenerator 7 associated with each heating area Z1, Z2, Z3, and therefore in this example with three rotary regenerators 7. The role of these rotary regenerators 7 is to reheat a predetermined flow rate of supply air 8 in such a manner as to provide a predetermined flow rate of preheated combustion air 9. The use of preheated combustion air Ac makes it possible to increase the efficiency of the first combustion considerably by reducing the quantity of natural gas Gn required for said combustion, and therefore to increase the energy efficiency of the furnace 1.

Each rotary regenerator 7 is suitable for receiving a predetermined flow rate of recovery fumes 10 via a first duct 11, for receiving a predetermined flow rate of supply air 8 via a second duct 12, for preheating said supply air Aa in order to supply the burners 3 of the heating area associated with the rotary generator 7 with the predetermined flow rate of preheated combustion air 9 via a third duct 14, and for discharging exhaust fumes F3 via a fourth duct 15.

Each rotary regenerator 7 is supplied continuously with the predetermined flow rate of supply air 8 and with the predetermined flow rate of recovery fumes 10. In known manner, each rotary regenerator 7 includes rotary compartments that are put into communication for a first half of the time with the first duct 11, thereby enabling the inside of the regenerator 7 to be heated, and then for a second half of the time with the second duct 12, thereby enabling the rotary regenerator 7 to be supplied with supply air Aa. The supply air Aa, which is never in contact with the recovery fumes, is thus preheated, thereby enabling the associated burner 7 to be provided with the predetermined flow rate of preheated combustion air 9.

The recovery fumes F2 are distributed among the rotary regenerators 7 in such a manner as to ensure that a certain distribution ratio is always conserved between the predetermined flow rate of supply air 8 and the predetermined flow rate of recovery fumes 10.

Advantageously, it is sought to have a distribution ratio between the predetermined flow rate of supply air 8 and the predetermined flow rate of recovery fumes 10 that lies in the range 1 to 1.2 approximately, such a distribution ratio making it possible to optimize the energy efficiency of the furnace.

In order to obtain the desired distribution ratio, initially, the predetermined flow rate of recovery fumes 10 received by each rotary regenerator 7 are is regulated by first regulator comprising a first valve 17 mounted on a fourth duct 15 of said rotary regenerator 7. Thus, for each rotary regenerator 7, the predetermined flow rate of recovery fumes 10 is regulated indirectly, by regulating the flow rate of exhaust fumes F3. This regulation is performed in particular by way of the first valve 17, which is mounted downstream from said rotary regenerator 7, i.e. that is situated between the rotary regenerator 7 and a fume outlet S2 of the furnace which in this example is put into communication with a chimney 25 via which the exhaust fumes are discharged from the oven 1.

In addition, the predetermined flow rate of supply air 8 received by each rotary regenerator 7 is regulated by second regulator comprising a second valve 20 mounted on the second duct 12 of said rotary regenerator 7. Thus, for each rotary regenerator 7, the predetermined flow rate of supply air 8 is regulated directly by way of the second valve 20 in particular, which makes it possible to eliminate possible inaccuracies of regulation due to possible leaks between supply air and recovery fumes inside the rotary regenerators 7.

In order to regulate the predetermined flow rate of recovery fumes 10 and the predetermined flow rate of supply air 8, it is necessary to measure the predetermined flow rate of combustion air 9. To do so, a flowmeter 21 is mounted on the third duct 14 of each rotary regenerator 7, each flowmeter 21 being adapted to measure the flow rate of combustion air 9 provided to the burners 3 of the heating area Z1, Z2, Z3 associated with said rotary regenerator 7. Advantageously, it is preferred to use a flow rate measurement that generates little loss of pressure in the duct, thus making it possible to maintain the combustion air at a relatively low pressure. Thus, it is preferable to select a flowmeter 21 of the Venturi tube or Pitot tube or Vortex effect type.

The preheated combustion air is raised to temperatures typically lying in the range 800 degrees Celsius to 1000 degrees Celsius, while the exhaust fumes are raised to temperatures typically lying in the range 150 degrees Celsius to 250 degrees Celsius.

It should be observed that the first and second regulators, respectively comprising the first 17 and second valves 20, are situated on the fourth 15 and second ducts 8, which present temperatures that are relatively low compared to the first 11 and third ducts 14. These regulators thus constitute a less costly and more reliable solution than a similar solution situated on the hotter ducts.

In addition, it is sought to be able to provide, if necessary, a connection between the third duct 14 and the inside of the thermally insulated enclosure 2 that is completely sealed. Indeed, when one or more heating areas Z1, Z2, Z3 are not in use, for example because of a reduction in the travel speed of the steel strip 4 inside the enclosure 2, it is essential to avoid any combustion air penetrating into the enclosure. Such penetration of air would tend to reduce the advantages of the above-mentioned sub-stoechiometric operating conditions.

Since a simple valve may not be completely leaktight, two disconnector valves 22 are mounted on the third duct 14 of each rotary regenerator, and injector 23 for injecting inert gas, specifically nitrogen, are mounted on the third duct 14 in order to fill a space between the two disconnector valves 23 with gas. Positive pressure is thus maintained between the two disconnector valves 23, so that in the event of a leak via one of the disconnector valves, only a leakage flow of inert gas would be able to penetrate the enclosure 2.

Advantageously, the post-combustion air (Apc) comes in part from the preheated combustion air generated by at least one rotary regenerator, which may possibly be overdimensioned for this purpose. This makes it possible to further improve the energy efficiency of the furnace.

The invention is not limited to the particular embodiment described above, but, on the contrary, covers any variant coming within the ambit of the invention. In particular, it is possible to provide a furnace having some other number of burners distributed over some other number of heating areas. The temperature ranges are provided by way of indication, and may of course differ in various applications using the furnace of embodiments of the invention.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: An industrial furnace for heating products such as steel products, the furnace comprising:
a thermally-insulated enclosure;
a plurality of burners arranged in the enclosure for heating products passing from one end of the enclosure to the other, the burners being distributed over a plurality of temperature-regulated heating areas; and
a recovery system for recovering heat energy from recovery fumes by a first combustion performed by the burners in such a manner as to improve energy efficiency of the furnace, the recovery system including a rotary regenerator associated with each heating area, each of the rotary regenerators being configured to receive a predetermined flow rate of recovery fumes via a first duct, receive a predetermined flow rate of supply air via a second duct, preheat the supply air in order to supply the burners of the associated heating area with a predetermined flow rate of preheated combustion air via a third duct, and discharge exhaust fumes via a fourth duct.

2: The industrial furnace according to claim 1, wherein the predetermined flow rate of recovery fumes received by each rotary regenerator is regulated a first regulator comprising a first valve mounted on the fourth duct of the rotary regenerator.

3: The industrial furnace according to claim 1, wherein the predetermined flow rate of supply air received by each rotary regenerator is regulated by a second regulator comprising a second valve mounted on the second duct of the rotary regenerator.

4: The industrial furnace according to claim 1, wherein, for each rotary regenerator, a flowmeter is mounted on the third duct of the rotary regenerator.

5: The industrial furnace according to claim 4, wherein at least one of the flowmeters is of the Venturi tube or Pitot tube or Vortex effect type flowmeter.

6: The industrial furnace according to claim 1, wherein, for each rotary regenerator, two disconnector valves are mounted on the third duct, and gas injection means are mounted on the third duct in order to fill the space between the two disconnector valves with inert gas.

7: The industrial furnace according to claim 6, wherein the injected gas is nitrogen.

8: The industrial furnace according to claim 1, wherein the recovery fumes are generated by a second combustion making it possible to finish off the first combustion performed by the burners.

9: The industrial furnace according to claim 8, wherein post-combustion air used for the second combustion comes in part from the preheated combustion air generated by at least one rotary regenerator.

10: The industrial furnace according to claim 1, wherein a ratio between the predetermined flow rate of supply air and the predetermined flow rate of recovery fumes lies in the range of 1 to 1.2.
